(19) United States
(12) Patent Application Publication
(10) Pub. No.: US 2007/0242038 A1
(43) Pub. Date: Oct. 18, 2007

(54) THIN FILM SWITCH WITH CHANGEABLE OUTLET JOINT

(75) Inventor: Feng-Ting Hsu, Taipei Hsien (TW)

Correspondence Address: J C PATENTS, INC., 4 VENTURE, SUITE 250, IRVINE, CA, 92618, US

(73) Assignee: JENSIN INTL TECHNOLOGY CORP., Taipei County (TW)

(21) Appl. No.: 11/735,873

(22) Filed: Apr. 16, 2007

(30) Foreign Application Priority Data
Apr. 17, 2006 (TW) 95113603

(51) Int. Cl. G09G 5/00; H01H 9/00

(52) U.S. Cl. 345/156; 200/292

(57) ABSTRACT

A thin film switch with a changeable outlet joint includes two thin films, a touch circuit, and a soft flat cable. The two thin films have two opposite inner surfaces. The touch circuit includes a plurality of touch portions and an outlet end, which are disposed on the two opposite inner surfaces of the two thin films. Each couple of the touch portions switches to a conducting state when receiving a press action and transfers a signal to the outlet end. The soft flat cable includes a connecting portion. The soft flat cable is connectably disposed on the outlet end through the connecting portion to form an outlet joint.

### CROSS-REFERENCE TO RELATED APPLICATION

This application claims the priority benefit of Taiwan application serial no. 95113603, filed Apr. 17, 2006. All disclosure of the Taiwan application is incorporated herein by reference.

### BACKGROUND OF THE INVENTION

1. Field of the Invention

The present invention relates to a thin film switch. More particularly, the present invention relates to a thin film switch with a changeable outlet joint.

2. Description of Related Art

A thin film switch has a plurality of touch portions disposed on the inner surfaces of two opposite thin films respectively, and each couple of opposite touch potions touches each other under an external compression to conduct a circuit, thereby achieving a desired switch function to generate a signal. After being connected with circuits, several sets of thin film switches are able to be combined into a set of input device as a printed circuit board (PCB) of a notebook PC keyboard.

FIG. 1A is a schematic view of a conventional thin film switch with an outlet joint applied in a notebook PC keyboard. Generally speaking, a conventional thin film switch 10a with an outlet joint as shown in FIG. 1A in design and fabrication usually comprises a set of outlet joints 30a for connecting other hardware such as a motherboard, in addition to a thin film switch body 20a. However, since various customized products and the design thereof by different manufacturers are different in terms of the position and number of keys or touch portions 22a, the specification of thin film body 20a, the position of outlet end 24a, and the direction, length, and position of the outlet joint 30a, as for suppliers of thin film switch 10a, the flexibility of the production line and production scheduling is limited.

For example, in a thin film switch body 20b of another conventional thin film switch 10b with an outlet joint as shown in FIG. 1B, the position and number of touch portions 22b, the specification of the thin film switch body 20b, and the position of an outlet end 24b are all the same as those of the thin film switch body 20a as shown in FIG. 1A. However, the direction, length, and position of an outlet joint 30b are different from those of the outlet joint 30a of the conventional thin film switch 10a with an outlet joint as shown in FIG. 1A, so the two thin film switches cannot be scheduled into the same production line. In another conventional thin film switch 10c with an outlet joint as shown in FIG. 1C, the position and number of touch portions 22c, the specification of a thin film switch body 20c, and the position of an outlet joint 30c are the same as those of the conventional thin film switch 10a with an outlet joint as shown in FIG. 1A. However, the position of an outlet end 24c is different from that of the outlet end 24a of the conventional thin film switch 10a with an outlet joint as shown in FIG. 1A, so the two thin film switches cannot be scheduled into the same production line. In addition, since the specifications of the thin film switches designed by various manufacturers are different, diversified thin film switch products are provided by thin film switch suppliers, and thus the inventory control of the suppliers becomes more complex.

FIG. 2 is an expanded view of the conventional thin film switch 10a with an outlet joint of FIG. 1A before stack and alignment. As shown in FIG. 2, the conventional thin film switch 10a with an outlet joint tends to be limited by geometric shapes thereof, so that the required size of a thin film sheet 50 for manufacturing is larger. Furthermore, too much thin film waste 60 in blank may be generated, thereby causing the waste of the thin film sheet 50 material.

### SUMMARY OF THE INVENTION

Accordingly, the present invention is directed to a thin film switch with a changeable outlet joint, so as to enhance the flexibility of a production line, reduce the complexity in the inventory control, and reduce the wastage of thin film material.

The present invention is also directed to a keyboard with a changeable outlet joint, so as to enhance the flexibility of a production line, reduce the complexity in inventory control, and reduce the wastage of thin film material.

In order to achieve the aforementioned and other objectives of the present invention, the thin film switch with a changeable outlet joint is provided. The thin film switch comprises two thin films, a touch circuit, and a soft flat cable. The two thin films have two opposite inner surfaces. The touch circuit comprises a plurality of touch portions and an outlet end, which are disposed on the two opposite inner surfaces of the two thin films. Each couple of the touch portions switches to a conducting state when receiving a press action and transfers a signal to the outlet end. The soft flat cable comprises a connecting portion, and is connectably disposed on the outlet end through the connecting portion to form an outlet joint.

In an embodiment of the present invention, the soft flat cable comprises a thin film flat cable.

In an embodiment of the present invention, the connecting portion comprises a self adhesive tape or a hot press adhesive.

In an embodiment of the present invention, the connecting portion comprises an anisotropic conductive paste (ACP).

In an embodiment of the present invention, the thin film switch further comprises an insulating layer disposed between the two thin films, wherein the insulating layer comprises a plurality of holes corresponding to a couple of the touch portions respectively.

The keyboard with a changeable outlet joint provided by the present invention comprises a plurality of keys, a thin film switch, and a soft flat cable. The thin film switch receives the action of keys. The soft flat cable has a connecting portion, and is connectably disposed on the thin film switch through the connecting portion to form an outlet joint.

In an embodiment of the present invention, the thin film switch comprises two thin films and a touch circuit. The two thin films have two opposite inner surfaces. The touch circuit comprises a plurality of touch portions and an outlet end, which are disposed on the two opposite inner surfaces of the two thin films. Each couple of the touch portions switches to a conducting state when receiving a press action of a corresponding key and transfers a signal to the outlet end, wherein the outlet end is connected to the connecting portion.

In an embodiment of the present invention, the thin film switch further comprises an insulating layer disposed between the two thin films, wherein the insulating layer has a plurality of holes corresponding to a couple of the touch portions respectively.

In an embodiment of the present invention, the soft flat cable comprises a thin film flat cable.

In an embodiment of the present invention, the connecting portion comprises a self adhesive tape or a hot press adhesive.

In an embodiment of the present invention, the connecting portion comprises an anisotropic conductive paste.

In the present invention, the soft flat cable and the thin film switch are separately designed and manufactured, and are not limited to the conventional design, thereby greatly improving the flexibility of the production line and the stock, effectively reducing the wastage of thin film material, and enhancing the substitution of products.

In order to the make aforementioned and other objects, features and advantages of the present invention comprehensible, preferred embodiments accompanied with figures are described in detail below.

### BRIEF DESCRIPTION OF THE DRAWINGS

FIG. 1A is a schematic view of a conventional thin film switch with an outlet joint.

FIG. 1B is a schematic view of another conventional thin film switch with an outlet joint.

FIG. 1C is a schematic view of still another conventional thin film switch with an outlet joint.

FIG. 2 is a view of the conventional thin film switch with an outlet joint as shown in FIG. 1A before folding and alignment.

FIG. 3A is a combination view of a thin film switch with a changeable outlet joint according to an embodiment of the present invention.

FIG. 3B is an exploded view of a thin film switch body and a soft flat cable of FIG. 3A.

FIG. 3C is a schematic view of a soft flat cable according to another embodiment of the present invention.

FIG. 4 is a sectional view of the touch unit of FIG. 3A.

FIG. 5 is a schematic view of the size of a thin film sheet used for the thin film switch of FIG. 3B in simulated production.

FIG. 6A is a schematic view of the size of a thin film used for the soft flat cable in FIG. 3B in simulated production.

FIG. 6B is a schematic view of another combination of FIG. 6A.

FIG. 7 is an isometric view of a notebook PC keyboard with a changeable outlet joint according to an embodiment of the present invention.

### DESCRIPTION OF EMBODIMENTS

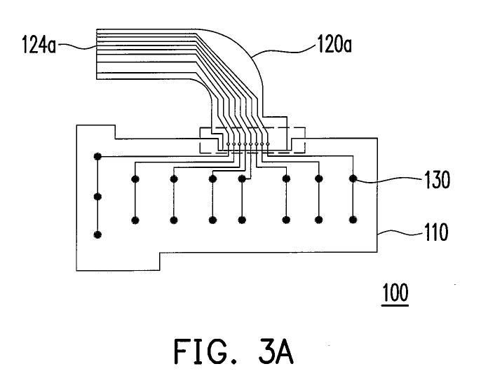

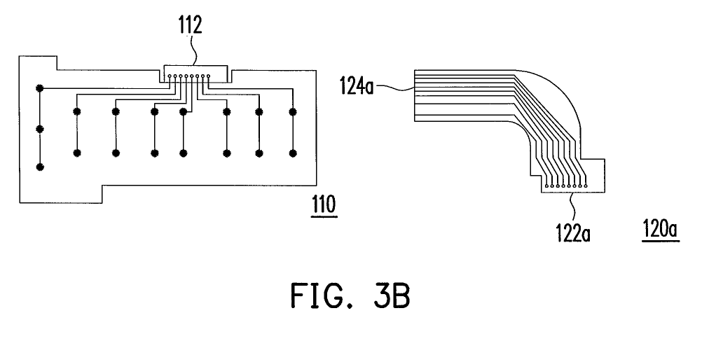

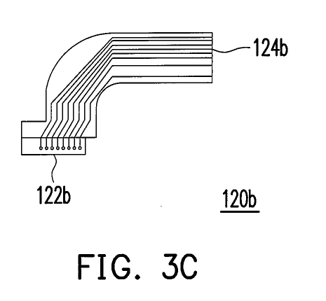

FIG. 3A is a view of the thin film switch 100 with a changeable outlet joint according to an embodiment of the present invention. The thin film switch 100 with a changeable outlet joint includes a thin film switch body 110 and a soft flat cable 120a, wherein the thin film switch body 110 includes a plurality of touch units 130. FIG. 3B is an exploded view of the thin film switch body 110 and the soft flat cable 120a of FIG. 3A. Referring to FIG. 3B, after the soft flat cable 120a is connectably disposed on an outlet end 112 of the thin film switch body 110 through a connecting portion 122a, the end 124a of the soft flat cable 120a as shown in FIG. 3A is formed. The soft flat cable 120a can be a conventional thin film flat cable or a flexible printed circuit board. In the present invention, the material of the soft flat cable 120a is the same as that of the thin film switch and may be also be fabricated by the same process. The connecting portion 122a may be a binding material including a self adhesive tape, a hot press adhesive, an anisotropic conductive paste, and the like.

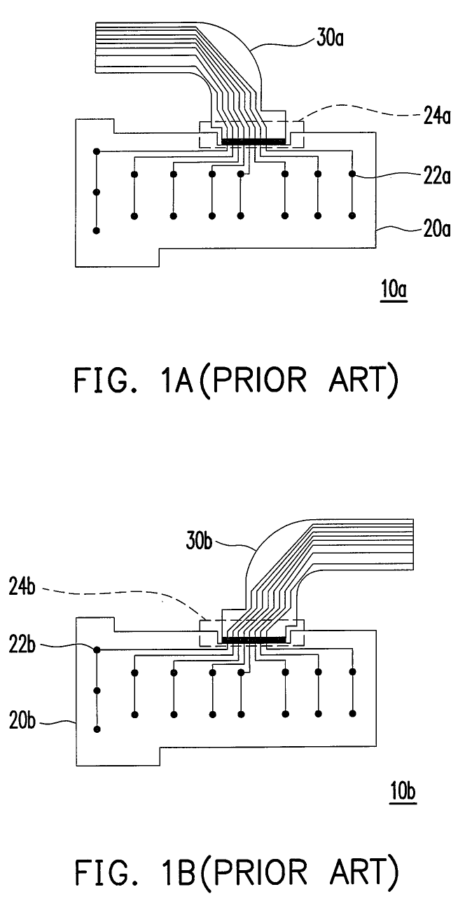

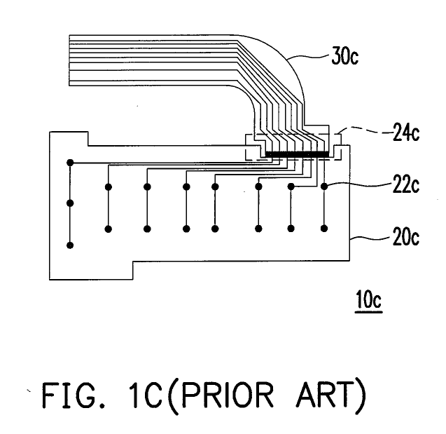

FIG. 3C is a schematic view of a soft flat cable 120b according to another embodiment of the present invention. A connecting portion 122b is the same as the connecting portion 122a of FIG. 3B except for the extending direction and position of an end 124b are different from those of the end 124a of FIG. 3B. Compared to the conventional film switches 10a and 10b, as shown in FIGS. 1A and 1B, which require two separate production line for fabrication thereof due to the different extending directions and positions of the outlet joints 30a and 30b, the present invention employs the same thin film switch body 110 with different soft flat cables 120a and 120b to form the two conventional thin film switches 10a and 10b (FIGS. 1A and 1B), as shown in FIGS. 3B and 3C. Furthermore, as shown in FIGS. 1A and 1C, when the position of the outlet ends 24a and 24c of the thin film switches 10a and 10c are different, and the number and position of the touch portions 22a and 22c and the composition of the outlet ends 24a and 24c are the same, the thin film switch 20c of FIG. 1C may be modified to be fabricated together with the thin film switch body 110 through the same production line, and then is used with another soft flat cable. Therefore, the present invention may effectively improve the flexibility of the production line and the substitution of thin film switches, and thereby effectively reduce the inventory of suppliers, and reduce the complexity in inventory control.

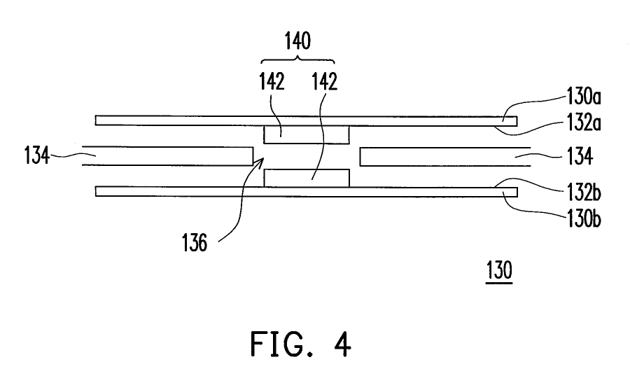

FIG. 4 is a sectional view of a touch unit 130 of the thin film switch body 110 in FIG. 3A. As shown in FIG. 4, the touch unit 130 includes two thin films 130a, 130b and a touch circuit 140. The two thin films 130a and 130b include two opposite inner surfaces 132a and 132b. The touch circuit 140 includes a plurality of touch portions 142, which are disposed on the two opposite inner surfaces 132a and 132b of the thin films 130a and 130b. Each couple of the touch portions 142 switches to a conducting state when receiving a press action, and transfers a signal to the outlet end 112 of FIG. 3B. The touch unit 130 further includes an insulating layer 134 disposed between the thin films 130a and 130b. The insulating layer 134 has a plurality of holes 136 corresponding to each couple of the touch potions 142 respectively.

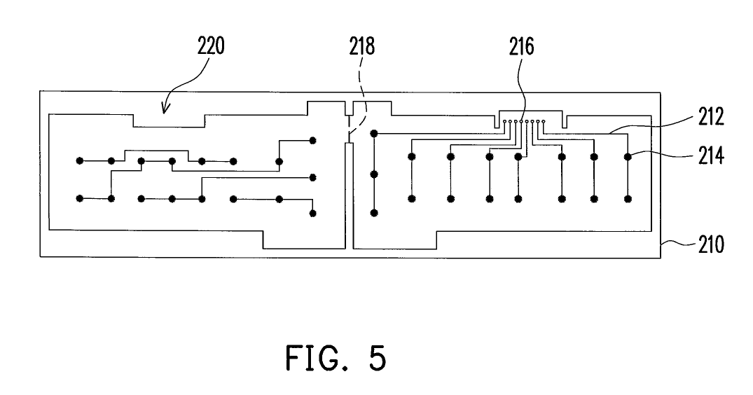

The thin film switch of the present invention may be fabricated in the same manner as that of the conventional thin film switch or the flexible printed circuit board. As shown in FIG. 5, a metal layer and a photoresist layer (not shown) is formed on a surface of a thin film 210, and the photoresist layer is exposed and developed to form a predetermined circuit pattern. Next, the metal layer is etched to form a desired circuit 212, touch portions 214, and an outlet end 216. Thin film waste 220 is cutoff according to a desired profile of the thin film 210, and then the thin film 210 is folded in half along a fold line 218. After that, an insulating layer is added and then laminated, so as to form the thin film switch 110 of FIG. 3B.

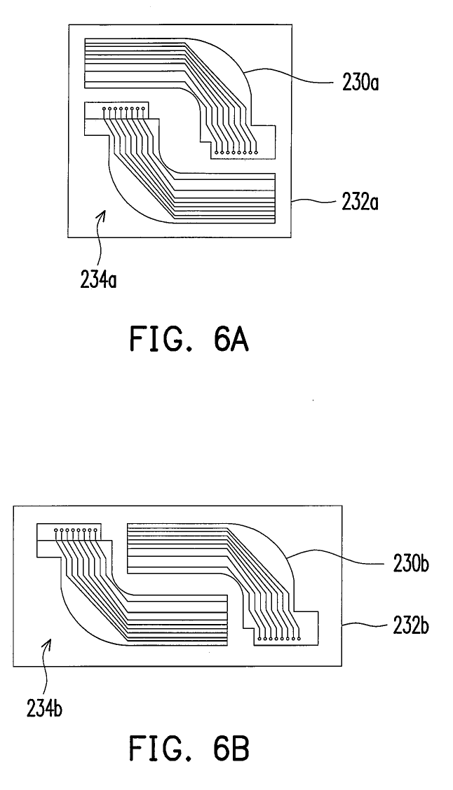

As shown in FIG. 6A, the soft flat cables 230a of the present invention can be arranged in pairs on the same thin film sheet 232a according to the geometric shape thereof and then processed simultaneously. The process of manufacturing the soft flat cables 230a is the same as that of the conventional thin film switch or the flexible printed circuit board, and the details will not be described herein again. Next, the thin film waste 234a is cutoff according to a desired profile. FIG. 6B is another embodiment of FIG. 6A. In this embodiment, soft flat cables 230b are arranged on a thin film sheet 232b in a different manner, and then thin film waste 234b is cutoff to form the two sets of soft flat cables 230b.

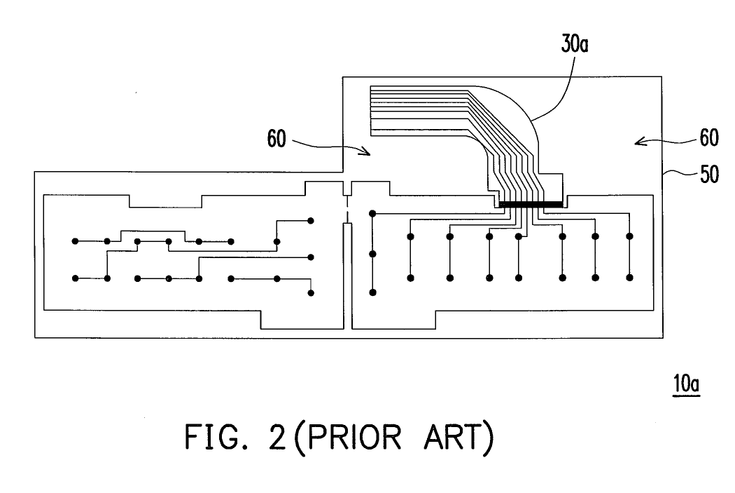

Comparing the thin film wastes 220, 234a, and 234b of FIGS. 5, 6A, and 6B with the thin film waste 60 of the conventional thin film switch 10a of FIG. 2, the conventional thin film switch 10a with an outlet joint generates comparatively more thin film waste 60 after being processed due to the limitation of the geometric shapes of the thin film switch body and the soft flat cables. In the present invention, since the thin film switch body and the soft flat cables are separately manufactured, the thin film material is effectively utilized and the thin film waste resulting from the processing is reduced.

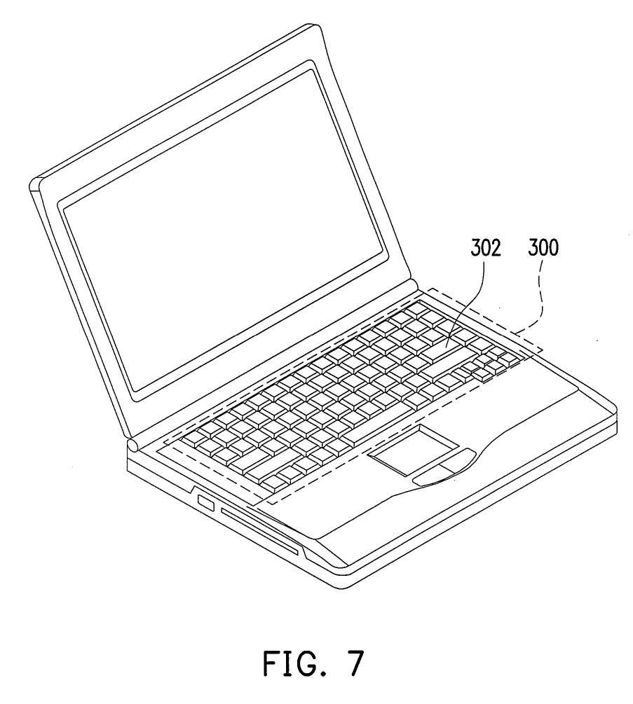

FIG. 7 is an isometric view of a notebook PC keyboard 300 with a changeable outlet joint according to an embodiment of the present invention. The schematic partial enlarged view of a thin film switch (not shown) at the bottom of the keyboard and the reference numbers can refer to FIG. 3A of an embodiment of the present invention. The keyboard 300 with a changeable outlet joint comprises a plurality of keys 302, a thin film switch 110, and a soft flat cable 120a. The composition of the thin film switch 110 and the soft flat cable 120a are the same as those in the preceding embodiment and the details will not be described herein again. The thin film switch 110 of FIG. 3A is mounted below the keys of FIG. 7, and each of the keys 302 must be aligned with the corresponding touch units 130 of FIG. 3A. Meanwhile, the end 124a of the soft flat cable 120a of FIG. 3A must be connected to a motherboard slot (not shown) of a notebook PC in FIG. 7. By pressing each of the keys 302, the corresponding touch unit 130 in FIG. 3A can generate and transmit a signal to the motherboard through the soft flat cable 120a, thereby achieving the desired data input function.

In view of the above, in the present invention, since the thin film switch and the soft flat cable are designed to be manufactured separately, it is unnecessary to manufacture the thin film switches with the same function and size through different production lines simply because of the outlet joints with different length or positions. Meanwhile, the thin film switches with the same function and size, which are originally designed to be manufactured separately due to the outlet joints with different positions, may be modified to have the same specification. Therefore, the present invention not only improves the flexibility of the production line and production scheduling, but also improves the substitution of the thin film switch. Meanwhile, the inevitable blank between the thin film switch and the soft flat cable in the conventional design can be eliminated because the thin film switch and the soft flat cable are manufactured separately, thereby reducing the waste of thin film material. Moreover, the complexity of the inventory control of the thin film switch suppliers caused by the diversification of products can also be effectively reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film switches with a changeable outlet joint, comprising:
two thin films, having two opposite inner surfaces;
a touch circuit, having a plurality of touch portions and an outlet end, which are disposed on the two opposite inner surfaces of the two thin films, wherein each couple of the touch portions switches to a conducting state in response to receiving a press action and transfers a signal to the outlet end; and
a soft flat cable, having a connecting portion, connectably disposed on the outlet end through the connecting portion to form an outlet joint.

2. The thin film switch with a changeable outlet joint as claimed in claim 1, wherein the soft flat cable comprises a thin film flat cable.

3. The thin film switch with a changeable outlet joint as claimed in claim 1, wherein the connecting portion comprises a self adhesive tape or a hot press adhesive.

4. The thin film switch with a changeable outlet joint as claimed in claim 1, wherein the connecting portion comprises an anisotropic conductive paste.

5. The thin film switch with a changeable outlet joint as claimed in claim 1, wherein the thin film switch further comprises an insulating layer disposed between the two thin films, and the insulating layer has a plurality of holes corresponding to a couple of the touch portions respectively.

6. A keyboard with a changeable outlet joint, comprising:
a plurality of keys;
a thin film switch, for receiving the action of the keys; and
a soft flat cable, having a connecting portion, connectably disposed on the thin film switch through the connecting portion to form an outlet joint.

7. The keyboard with a changeable outlet joint as claimed in claim 6, wherein the thin film switch comprises:
two thin films, having two opposite inner surfaces; and
a touch circuit, having a plurality of touch portions and an outlet end, which are disposed on the opposite inner surface of the thin films, wherein each couple of the touch portions switches to a conducting state in response to receiving a press action of keys and transfers a signal to the outlet end,
wherein the outlet end is connected to the connecting portion.

8. The keyboard with a changeable outlet joint as claimed in claim 7, wherein the thin film switch further comprises an insulating layer disposed between the two thin films, and the insulating layer has a plurality of holes which are corresponding to a couple of the touch portions respectively.

9. The keyboard with a changeable outlet joint as claimed in claim 6, wherein the soft flat cable comprises a thin film flat cable.

10. The keyboard with a changeable outlet joint as claimed in claim 6, wherein the connecting portion comprises a self adhesive tape or a hot press adhesive.

11. The keyboard with a changeable outlet joint as claimed in claim 6, wherein the connecting portion is an anisotropic conductive paste.
